(19) United States
(12) Patent Application Publication
(10) Pub. No.: US 2026/0225508 A1
(43) Pub. Date: Aug. 6, 2026

(54) VEHICLE CENTER CONSOLE BOX

(71) Applicant: Honda Motor Co., Ltd., Tokyo (JP)

(72) Inventors: JACOB RANDANPEMO PERRY, DUBLIN, OH (US); DWAYNE WILLIAM MALONE, PLAINCITY, OH (US); TIMOTHY WARREN HUTCHINSON, DUBLIN, OH (US)

(21) Appl. No.: 19/043,261

(22) Filed: Jan. 31, 2025

(51) Int. Cl. B60N 2/75

(52) U.S. Cl. CPC B60N 2/763

(57) ABSTRACT

A console box for a vehicle is provided. The console box includes a console main body having a sliding rail disposed on a first longitudinal side of the console main body along a longitudinal direction of the console box. The console box further includes a console lid slidably arranged over the sliding rail such that the console lid slides from a first position to second position. The console box further includes a sliding pin having a first and second section. The first section is disposed on a second longitudinal side of the console lid and the second section slides in a front-rear direction inside a cavity provided on the sliding rail. Further, the console lid slides to the second position, allowing a thread embossed on an outermost surface of the second section d to receive a fixed pin fixedly arranged at a rearmost end of the console main body.

### BACKGROUND

A vehicle's center console is a storage compartment situated between the driver and front passenger seats. It is designed to offer convenient access to various items and enhance the overall functionality of the vehicle's interior. In some models, the center console features a sophisticated sliding lid mechanism that reveals additional storage space, thereby improving user convenience. This sliding lid can rotate and open when moved to the rearward (RR) position or simply rotate and open, providing easy access to the console bin. This design ensures that the storage compartment is both spacious and easily accessible, meeting the needs of the vehicle occupants. However, an important aspect of the sliding lid mechanism requires attention. When the sliding lid is in the upright position, it tends to slide forward, which may not be ideal for the occupants. To maintain the design's integrity and ensure user safety, it is crucial that once the sliding lid rotates from the RR position, it remains securely in place and does not slide forward unintentionally or accidentally.

Limitations and disadvantages of conventional and traditional approaches will become apparent to one of skill in the art, through comparison of described systems with few aspects of the present disclosure, as set forth in the remainder of the present application and with reference to the drawings.

### SUMMARY

According to an embodiment of the disclosure, a console box for a vehicle may be provided. The console box may include a console main body that may include a sliding rail disposed on a first longitudinal side of the console main body along a longitudinal direction of the console box. The console box may further include a console lid that may be slidably arranged to the sliding rail such that the console lid may be slidable from a first position to a second position along an upper surface of the console main body. The console box may further include a sliding pin having a first section and a second section. The first section may be disposed on a second longitudinal side of the console lid and the second section may be slidable in a front-rear direction inside a cavity provided on the sliding rail. The console lid may be configured to slide to the second position, allowing a thread embossed on an outermost surface of the second section to receive a fixed pin fixedly arranged at a rearmost end of the console main body.

According to another embodiment of the disclosure, a vehicle body having a console box may be provided. The console box may include a console main body that may include a sliding rail disposed on a first longitudinal side of the console main body along a longitudinal direction of the console box. The console box may further include a console lid that may be slidably arranged to the sliding rail such that the console lid may be slidable from a first position to a second position along an upper surface of the console main body. The console box may further include a sliding pin having a first section and a second section. The first section may be disposed on a second longitudinal side of the console lid and the second section may be slidable in a front-rear direction inside a cavity provided on the sliding rail. The console lid may be configured to slide to the second position, allowing a thread embossed on an outermost surface of the second section to receive a fixed pin fixedly arranged at a rearmost end of the console main body.

According to another embodiment of the disclosure, a method for assembling a console box may be provided. The method may include disposing a sliding rail on a first longitudinal side of a console main body along a longitudinal direction of the console box. The method may further include slidably arranging a console lid to the sliding rail such that the console lid may be slidable from a first position to a second position along an upper surface of the console main body. The method may further include disposing a first section of a sliding pin on a second longitudinal side of the console lid such that a second section of the sliding pin may be slidable in a front-rear direction inside a cavity provided on the sliding rail. The console lid may be configured to slide to the second position, allowing a thread embossed on an outermost surface of the second section to receive a fixed pin fixedly arranged at a rearmost end of the console main body.

### BRIEF DESCRIPTION OF THE DRAWINGS

FIG. 1 is a diagram that illustrates a perspective view of an exemplary vehicle body having a console box, in accordance with an embodiment of the disclosure.

FIG. 2 is a diagram that illustrates a sectional view of a console box having a console lid at a first position, in accordance with an embodiment of the disclosure.

FIG. 3A is a scenario diagram that illustrates a sectional view of a console box having a console lid in a second position that provides access to a first storage section, in accordance with an embodiment of the disclosure.

FIG. 3B is a scenario diagram that illustrates a sectional view of a console box having a console lid in a second position that provides access to a first storage section and a second storage section, in accordance with an embodiment of the disclosure.

FIG. 4 is a diagram that illustrates a sectional view of a console box having a sliding pin embossed with a thread having a pitch, a fixed pin, a threaded surface, and an outer surface of the fixed pin, in accordance with an embodiment of the disclosure.

FIG. 5 is a flowchart that illustrates an exemplary method for assembling a console box, in accordance with an embodiment of the disclosure.

The foregoing summary, as well as the following detailed description of the present disclosure, is better understood when read in conjunction with the appended drawings. To illustrate the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

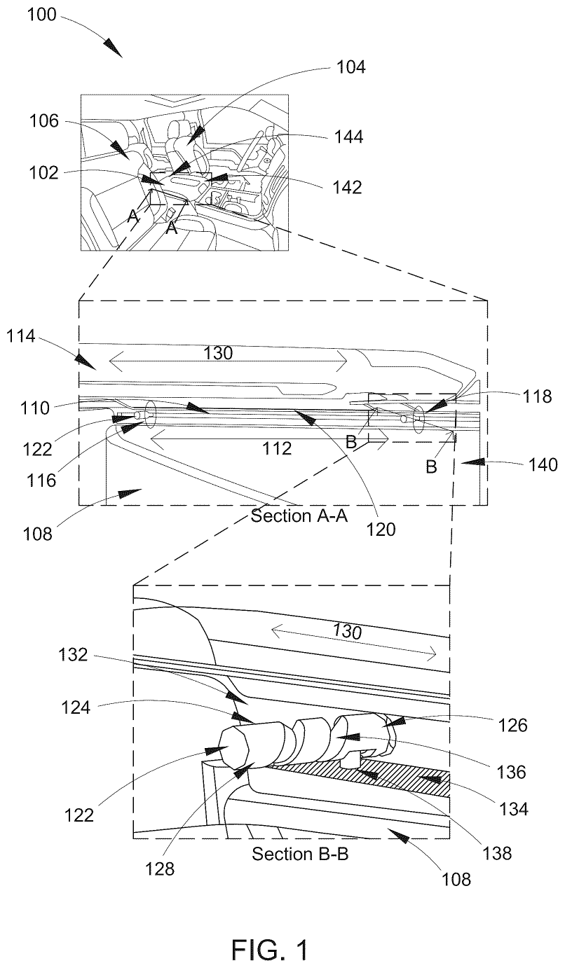

FIG. 1 is a diagram that illustrates a perspective view of an exemplary vehicle body having a console box, in accordance with an embodiment of the disclosure. With reference to the FIG. 1, there is shown a diagram that illustrates a vehicle body 100 of a vehicle. The vehicle body 100 may include a console box 102 disposed in between a driver seat 104 seat and a pedestrian seat 106. The console box 102 may include a console main body 108 having a sliding rail 110 disposed on first longitudinal side 112 of the console main body 108 (illustrated in detail about an A-A section). The console box 102 may further include a console lid 114 having second longitudinal side 130. The console lid 114 may be slidable from a first position 116 to a second position 118 along an upper surface 120 of the console main body 108. The console lid 114, the sliding rail 110, the first longitudinal side 112, the second longitudinal side 130, the first position 116, the second position 118, and the upper surface 120 are further illustrated in detail about an A-A section.

The console box 102 may further include a sliding pin 122 having an outermost surface 124, a first section 126, and a second section 128 (illustrated in detail about a B-B section). In some embodiments, the console box 102 may include a plurality of sliding pins (not shown) without departing from the scope of the present disclosure. The first section 126 may be disposed on the second longitudinal side 130. The sliding rail 110 may include a cavity 132 having an inner surface 134, as illustrated in detail about the B-B section. The console main body 108 may further include a thread 136 embossed on the outermost surface 124 of the second section 128 to receive a fixed pin 138 fixedly arranged at a rearmost end 140 of the console main body 108, as illustrated in detail about the B-B section.

The vehicle may be a means of transport with one or more storage boxes. Among the storage boxes at least one of the storage boxes may include the console box 102. The vehicle may be a four-wheeled vehicle which may be, for example, an electric car, an internal combustion engine (ICE)-based car, a fuel-cell based car, a solar powered-car, or a hybrid car. It should be noted that the four-wheeled vehicle is merely shown as an example in FIG. 1. The present disclosure may be also applicable to other types of vehicle (for example, trucks, manned airborne vehicles, or seaborne vehicles). The description of other types of vehicle has been omitted from the disclosure for the sake of brevity.

The vehicle body 100 may be a main support structure of the vehicle which may be configured to bear stresses induced on the vehicle. The vehicle body 100 may structurally supports a plurality of vehicle systems, such as, but not limited to a transmission system, a brake system, a suspension system, or a steering system. For example, the vehicle body 100 for the four-wheeled vehicle may include a plurality of components, such as, but not limited, a cabin, a roof body, suspension springs or bar, wheels, at least one axle, an engine, a motor, a fuel tank, seats, and steering.

The console box 102 for the vehicle may be a center storage box located inside a front cabin (not shown in FIG. 1) of the vehicle body 100. Preferably, the console box 102 may be disposed in the front cabin between the driver seat 104 and the pedestrian seat 106. The console box 102 may include the console main body 108 which have a substantially rectangular shape as shown in FIG. 1, for example. Alternatively, the console main body 108 may be formed to have another shape (for example, a substantially circular shape, a substantially elliptical shape, a substantially square shape, and the like), without a departure from the scope of the present disclosure. For example, the console main body 108 may be configured to provide a space to store items such as sunglasses, mobile phones, wallets, and other personal belongings.

The console box 102 may be referred to as a center console or a center console box. The console box 102 may serve as a storage compartment and may often house various items, such as but not limited to cup holders, armrests, and electronic controls for the vehicle's entertainment or climate systems. The console box 102 may be configured to be used as an armrest for the passenger or the driver of the vehicle. The position of the console box 102 between the driver seat 104 and the pedestrian seat 106 makes the console box 102 accessible to both the driver of the vehicle and the passenger sitting on the pedestrian seat 106 of the vehicle.

In some instances, the console main body 108 may include cup holders and charging ports to allow both the driver of the vehicle and the passenger sitting on the pedestrian seat 106 of the vehicle to charge electronic devices. For example, a rear portion of the console main body 108 may include air-conditioner vents to provide air to the passengers in the vehicle's rear cabin (not shown in FIG. 1). The height of the console main body 108 may be adjustable as per the convenience of the driver or the passenger.

The console main body 108 may include the sliding rail 110 that may be disposed on the first longitudinal side 112 of the console main body 108 along a longitudinal direction of the console box 102. The longitudinal direction of the console box 102 may be along a longitudinal length of the console main body 108. The length of the sliding rail 110 may be equal to the length of the first longitudinal side 112 of the console main body 108. Alternatively, the length of the sliding rail 110 may not be equal to the length of the first longitudinal side 112 of the console main body 108. The length of the console main body 108 may include a front portion 142 of the console main body 108 and a rear portion 144 of the console main body 108. The front portion 142 of the console main body 108 may be proximal to a gear lever (not shown) of the vehicle and the rear portion 144 of the console main body 108 may be proximal to a rear cabin (not shown) of the vehicle. The first longitudinal side 112 may be located on both first side (which may be proximal to the pedestrian seat 106) and a second side (not shown) of the console main body 108 (which may be proximal to the driver seat 104).

The sliding rail 110 may be a track encased within the first longitudinal side 112 of the console main body 108. The sliding rail 110 may be configured to accommodate the sliding pin 122 having the first section 126 and the second section 128. The second section 128 of the sliding pin 122 may be inserted into the cavity 132 provided on the sliding rail 110. The sliding rail 110 may provide a path to the sliding pin 122 to slide in the front-rear direction inside the cavity 132 (as shown in A-A section and B-B section of FIG. 1).

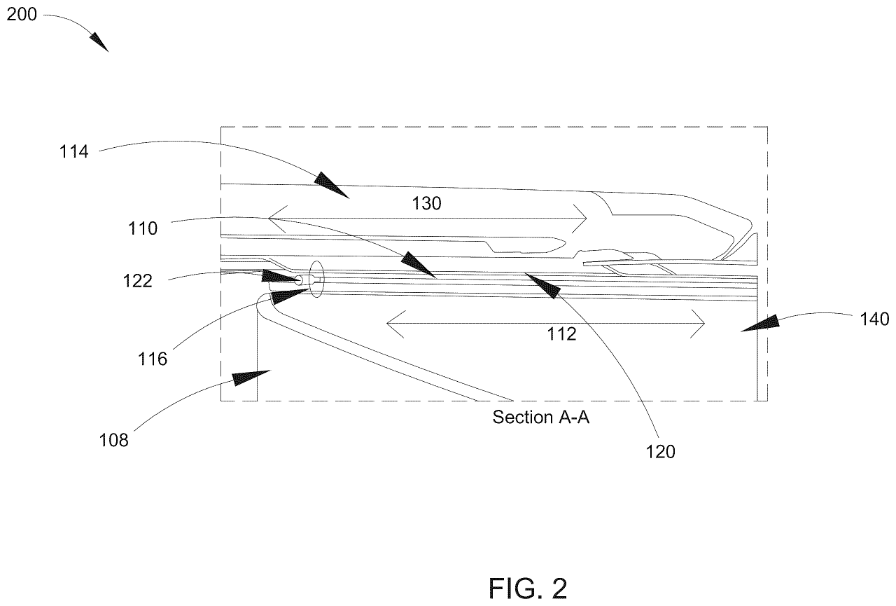

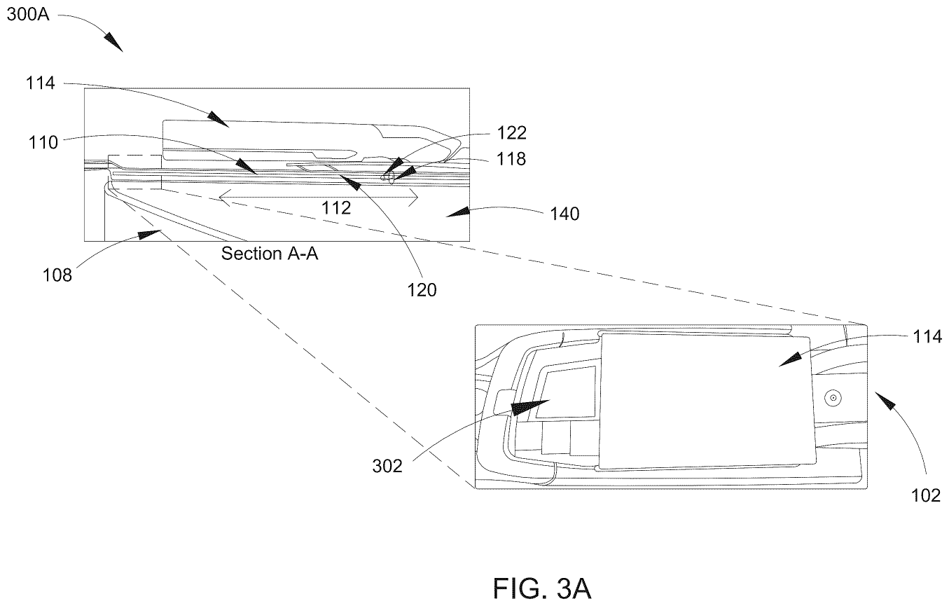

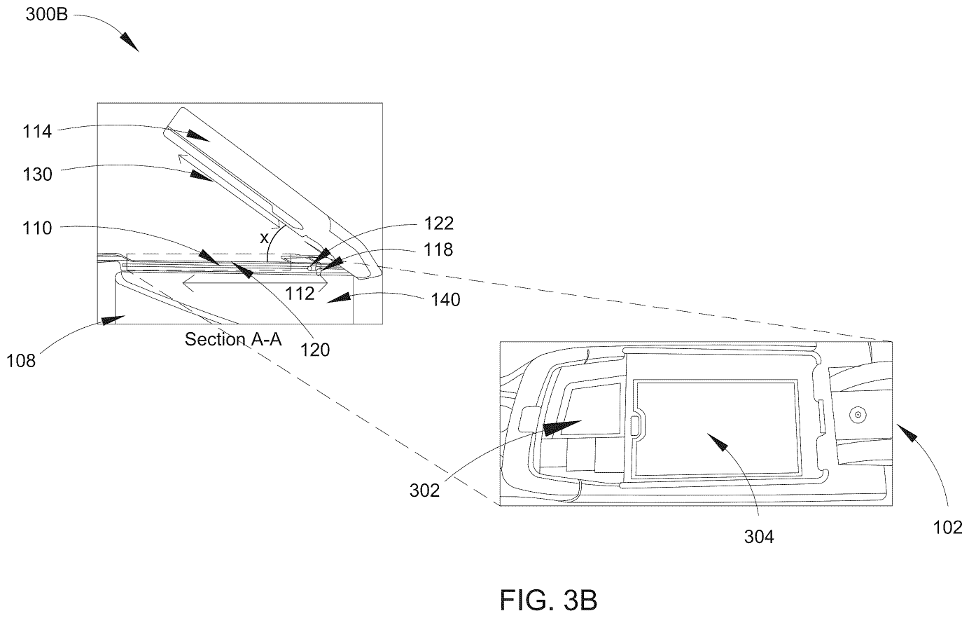

The console lid 114 of the console box 102 may be slidably arranged to the sliding rail 110 such that the console lid 114 is slidable from the first position 116 to the second position 118 along the upper surface 120 of the console main body 108. The first position 116 may be a closed state of the console box 102 (shown in a detailed manner in FIG. 2). The second position 118 may be an opened state of the console box 102 that may have two scenarios (shown in a detailed manner in FIG. 3A and FIG. 3B).

The console lid 114 may provide a covering over the upper surface 120 of the console main body 108, thereby closing and securing the console main body 108. Additionally, the console lid 114 may protect items kept inside the console main body 108 from getting exposed to any foreign particles or dust. Based on rotation of the sliding pin 122, the console lid 114 may slide over the upper surface 120 of the console main body 108. In some instances, the console lid 114 may be stitched with a soft cushioned concealment to provide a soft touch to the driver or the passenger. Further, the material used for the soft cushioned concealment may include, for example, leather or Rexene.

The shape of the console lid 114 may depend on the shape of the console main body 108. In FIG. 1, the shape of the console lid 114 is shown to have a substantially rectangular shape, which is merely an example. Alternatively, the console lid 114 may be formed to have another shape (for example, a substantially circular shape, a substantially elliptical shape, a substantially square shape, and the like), without a departure from the scope of the present disclosure.

The sliding pin 122 may include the first section 126 and the second section 128. The first section 126 may be disposed on the second longitudinal side 130 of the console lid 114 and the second section 128 may be slidable in a front-rear direction inside the cavity 132. Due to the sliding in the front-rear direction, the console lid 114 may be configured to slide from the first position 116 to the second position 118, which may provide access to a first storage section 302 (as shown in FIG. 3A). The first section 126 of the sliding pin 122 may bear the load of the console lid 114.

Further, the second longitudinal side 130 may be located on both third side (not shown) of the console lid 114 (which may be proximal to the pedestrian seat 106) and fourth side (not shown) of the console lid 114 (which may be proximal to the driver seat 104). The third side and the fourth side of the console lid 114 may be parallel to the first side and the second side of the console main body 108, respectively.

The outermost surface 124 of the second section 128 may be a circumferential surface of the sliding pin 122 and may be rotatably attached to the second longitudinal side 130 of the console lid 114. For example, when the console lid 114 slides from the first position 116 to the second position 118, the sliding pin 122 may rotate in a clockwise or anticlockwise direction. The console lid 114 and the sliding pin 122 may be disposed within the cavity 132 of the sliding rail 110, as shown in FIG. 1.

The cavity 132 provided on the sliding rail 110 may refer to a hollow space or channel provided within the sliding rail 110. The cavity 132 may be designed to accommodate the second section 128 of the sliding pin 122. The sliding mechanism (not shown) inside the cavity 132 may include but not limited to a drawer runner or a sliding door track system. The sliding mechanism may include additional elements such as ball bearings or rollers that may facilitate a sliding action of the sliding pin 122 within the cavity 132. There may be a clearance between the outermost surface 124 of the second section 128 and the inner surface 134 of the cavity 132. The clearance provides smooth and guided motion to the sliding pin 122. The sliding pin 122 may slide within the sliding rail 110 in the front-rear direction inside the cavity 132, ensuring stability and reducing friction.

The sliding pin 122 may slide from the first position 116 to the second position 118 that allows the console lid 114 to slide from the first position 116 to the second position 118. The console lid 114 may be configured to slide to the second position 118, allowing the thread 136 embossed on the outermost surface 124 of the second section 128 to receive the fixed pin 138 fixedly arranged at the rearmost end 140 of the console main body 108. The rearmost end 140 may correspond to the second position 118 of the console lid 114. The sliding pin 122 may rotate and slide to the second position 118 to align with the fixed pin 138. The fixed pin 138 may restrict the console lid 114 to slide back to the first position 116, which aids the console lid 114 to remain at the second position 118 and does not slide back towards the first position 116 unintentionally or accidentally. Further, the console lid 114 at the second position 118 may be configured to provide access to a first storage section (a first storage section 302, as shown in FIG. 3A) and a second storage section (a second storage section 304, as shown in FIG. 3B).

FIG. 2 is a diagram that illustrates sectional view of a console box having a console lid at a first position, in accordance with an embodiment of the disclosure. FIG. 2 is explained in conjunction with elements from FIG. 1. With reference to the FIG. 2, there is shown a diagram 200 that may include the console lid 114, the first position 116, the console main body 108, and the sliding pin 122.

The first position 116 (as shown in FIG. 1) may be a closed state of the console box 102. In the closed state of the console box 102 the console lid 114 may be located proximal to a dashboard (not shown in FIG. 2) of the vehicle. The console lid 114 may be configured to protect items stored inside the console main body 108 from getting exposed to any foreign particles or dust. Moreover, the console lid 114 in the closed state may be used as an arm rest that allows the driver or the passenger to rest their arms over the console lid 114.

FIG. 3A is a scenario diagram that illustrates a sectional view of a console box having a console lid in a second position that provides access to a first storage section, in accordance with an embodiment of the disclosure. FIG. 3A is explained in conjunction with elements from FIG. 1 and FIG. 2. With reference to the FIG. 3A, there is shown a scenario diagram 300A that may include the console lid 114, the second position 118, a first storage section 302, the console main body 108, and the sliding pin 122.

The console lid 114 at the second position 118 may be configured to provide access to the first storage section 302 in the console main body 108 and the console lid 114 may be substantially parallel to the upper surface 120 of the console main body 108. The first storage section 302 may be located proximal to the dashboard of the vehicle. For example, the first storage section 302 may expose half or less than half of the total area of the console main body 108.

The console lid 114 may slide from the first position 116 to the second position 118, that allows access of the first storage section 302 to the driver or the passenger. The first storage section 302 may include features like cup holders, USB ports, and sometimes even a small cooler compartment. The first storage section 302 allows the passenger or the driver to access essential items from the console box 102 while driving the vehicle. It should be noted that the first storage section 302 may only be accessed by the passenger and the driver while the console lid 114 is at the second position 118.

FIG. 3B is a scenario diagram that illustrates a sectional view of a console box having a console lid in a second position that provides access to a first storage section and a second storage section, in accordance with an embodiment of the disclosure. FIG. 3B is explained in conjunction with elements from FIG. 1, FIG. 2, and FIG. 3A. With reference to the FIG. 3B, there is shown a diagram 300B that may include the console lid 114, the second position 118, the first storage section 302, a second storage section 304, an angle X, the console main body 108, and the sliding pin 122.

The console lid 114 at the second position 118 may provide access to the first storage section 302 in the console main body 108 and the second storage section 304 in the console main body 108. The console box 102 in which the console lid 114 is at the second position 118 may provide access to the second storage section 304 in the console main body 108. The second storage section 304 may be adjacent to the first storage section 302 and the console lid 114 may be substantially at the angle X from the upper surface 120 of the console main body 108. For example, the second storage section 304 may expose more than half of the total area or the total area of the console main body 108. The second storage section 304 may be accessed by the driver or the passenger, as the console lid 114 slides from the first position 116 to the second position 118 and remains substantially at the angle X. For example, the angle X may be in a range of 30 to 90 degrees from the upper surface 120 of the console main body 108.

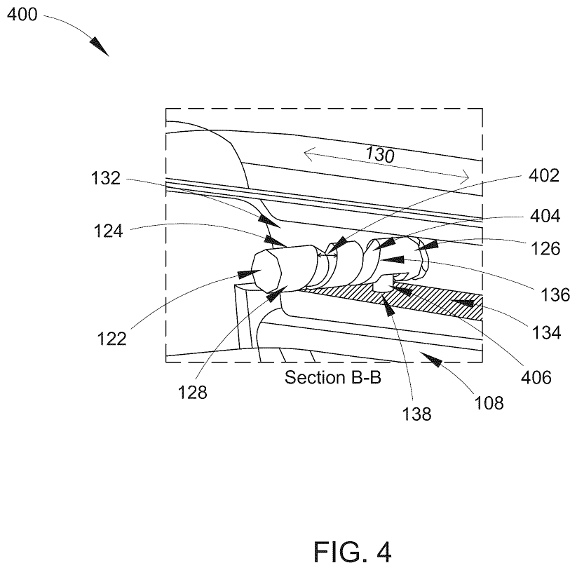

The second storage section 304 may include features like cup holders, USB ports, and sometimes even a small cooler compartment. The second storage section 304 allows the passenger or the driver to access essential items from the console box 102 while driving the vehicle. The console lid 114 may be configured to slide to the second position 118, allowing the thread 136 embossed on the outermost surface 124 of the second section 128 to receive the fixed pin 138 fixedly arranged at the rearmost end 140 of the console main body 108. The passenger or the driver may then rotate the console lid 114 about an axis (not shown in FIG. 3B). For example, the axis may be substantially perpendicular to the longitudinal direction of the console box 102. The rotation of the console lid 114 causes the console lid 114 to rotate substantially at the angle X from the upper surface 120 of the console main body 108. The console lid 114 at the angle X may be configured to provide access to both the first storage section 302 and the second storage section 304. As an example, both the first storage section 302 in the console main body 108 and the second storage section 304 in the console main body 108 are shown along A-A section of FIG. 3B. The second storage section 304 may be proximal to the passenger seats located at the rear cabin of the vehicle. The thread 136 embossed on the outermost surface 124 of the second section 128 may receive the fixed pin 138 fixedly arranged at the rearmost end 140 of the cavity 132, as further described in detail, for example in FIG. 4.

FIG. 4 is a diagram that illustrates a sectional view of a console box having a sliding pin embossed with a thread having pitch, a fixed pin, a threaded surface, and an outer surface of the fixed pin, in accordance with an embodiment of the disclosure. FIG. 4 is explained in conjunction with elements from FIG. 1, FIG. 2, FIG. 3A, and FIG. 3B. With reference to the FIG. 4, there is shown a diagram 400 may include the sliding pin 122, the thread 136, a pitch 402, the fixed pin 138, a threaded surface 404, and an outer surface 406.

The pitch 402 of the thread 136 may be equal to a diameter of the fixed pin 138. For example, the diameter of the fixed pin 138 may be equal to a width of the pitch 402 of the thread 136. In some instances, the diameter of the fixed pin 138 may be smaller or larger than the width of the pitch 402 of the thread 136, restricting the thread 136 to receive the fixed pin 138. The thread 136 may include the threaded surface 404 that may be in a surface contact with the outer surface 406 of the fixed pin 138. This is to note that, there may be a clearance area in between the threaded surface 404 of the thread 136 and the outer surface 406 of the fixed pin 138, that allows a smooth transition of the thread 136 along the fixed pin 138.

According to an embodiment, the console lid 114 may be configured to rotate at the angle X (as shown in FIG. 3B) in a clockwise direction, after the thread 136 receives the fixed pin 138. Further, the thread 136 after receiving the fixed pin 138 allows the sliding pin 122 to rotate about the fixed pin 138 causing the console lid 114 to rotate substantially at the angle X. The thread 136 translates along the fixed pin 138, causing the sliding pin 122 to rotate at the second position 118 about the fixed pin 138. A rotation of the sliding pin 122 caused the console lid 114 to rotate about the axis (as described in detail for example in FIG. 3B.) For example, the axis may be substantially perpendicular to the longitudinal direction of the console box 102. The rotation of the sliding pin 122 in the second position 118 makes the console lid 114 to rotate at the angle X. Because the console lid 114 is at an angle X with respect to the upper surface 120 of the console main body 108, the driver or passenger may be able to access the first and second storage sections 302 and 304, respectively.

In an alternate embodiment, the console main body 108 may include a stopper (not shown) that may be configured to prevent the console lid 114 to fall freely over the upper surface 120 of the console main body 108 or arms of the driver or the passenger.

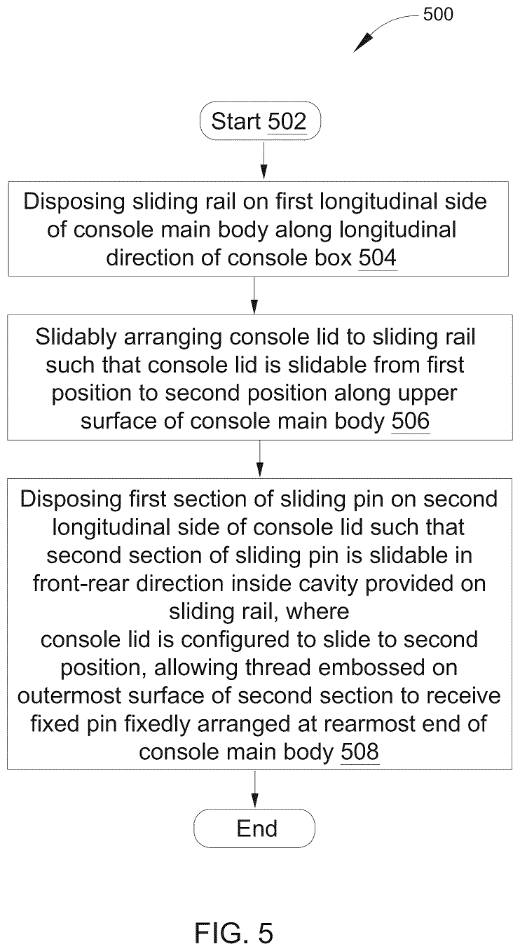

FIG. 5 is a flowchart that illustrates an exemplary method for assembling a console box, in accordance with an embodiment of the disclosure. FIG. 5 is explained in conjunction with elements from FIG. 1, FIG. 2, FIG. 3A, FIG. 3B, and FIG. 4. With reference to FIG. 5, there is shown a flowchart 500, which may depict method for assembling the console box 102 in a vehicle. The method illustrated in the flowchart 500 may start at 502 and proceed to 504.

At 504, the sliding rail 110 may be disposed on the first longitudinal side 112 of the console main body 108 main body along the longitudinal direction of the console box 102, as described, in detail, for example in FIG. 1.

At 506, the console lid 114 may be slidably arranged to the sliding rail 110 such that the console lid 114 may be slidable from the first position 116 to the second position 118 along the upper surface 120 of the console main body 108, as described, in detail, for example in FIG. 1.

At 508, the first section 126 of the sliding pin 122 may be disposed on the second longitudinal side 130 of the console lid 114 such that the second section 128 of the sliding pin 122 may be slidable in a front-rear direction inside the cavity 132 provided on the sliding rail 110. The console lid 114 may be configured to slide to the second position 118, allowing the thread 136 embossed on the outermost surface 124 of the second section 128 to receive the fixed pin 138 fixedly arranged at the rearmost end 140 of the console main body 108, as described, in detail, for example in FIG. 1.

Although the flowchart 500 is illustrated as discrete operations, such as 502, 504, 506, and 508, the disclosure is not so limited. Accordingly, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also, to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

1. A console box for a vehicle, comprising:
a console main body having a sliding rail disposed on a first longitudinal side of the console main body along a longitudinal direction of the console box;
a console lid slidably arranged to the sliding rail such that the console lid is slidable from a first position to a second position along an upper surface of the console main body; and
a sliding pin having a first section and a second section, and the first section being disposed on a second longitudinal side of the console lid and the second section is slidable in a front-rear direction inside a cavity provided on the sliding rail,
wherein the console lid is configured to slide to the second position, allowing a thread embossed on an outermost surface of the second section to receive a fixed pin fixedly arranged at a rearmost end of the console main body.

2. The console box according to claim 1, wherein the console box is disposed in a front cabin of the vehicle in between a driver seat and a pedestrian seat.

3. The console box according to claim 1, wherein the sliding pin rotates and slides to the second position to align with the fixed pin.

4. The console box according to claim 1, wherein the first position is a closed state of the console box, the console lid is in proximal to a dashboard of the vehicle and the second position is an open state of the console box, the console lid is in proximal to a rear cabin of the vehicle.

5. The console box according to claim 1, wherein the rearmost end corresponds to the second position of the console lid.

6. The console box according to claim 1, wherein the console box in which the console lid is at the second position provides access to a first storage section in the console main body, and the console lid is substantially parallel to the upper surface of the console main body.

7. The console box according to claim 1, wherein the console box in which the console lid is at the second position provides access to a second storage section in the console main body, the second storage section is adjacent to the first storage section, and the console lid is substantially at an angle X from the upper surface of the console main body.

8. The console box according to claim 7, wherein the thread after receiving the fixed pin allows the sliding pin to rotate about the fixed pin causing the console lid to rotate substantially at the angle X.

9. The console box according to claim 1, wherein a pitch of the thread is equal to a diameter of the fixed pin.

10. A vehicle body, comprising:
a console box for a vehicle that includes:
a console main body having a sliding rail disposed on a first longitudinal side of the console main body along a longitudinal direction of the console box;
a console lid slidably arranged to the sliding rail such that the console lid is slidable from a first position to a second position along an upper surface of the console main body; and
a sliding pin having a first section and a second section, and the first section being disposed on a second longitudinal side of the console lid and the second section is slidable in a front-rear direction inside a cavity provided on the sliding rail,
wherein the console lid is configured to slide to the second position, allowing a thread embossed on an outermost surface of the second section to receive a fixed pin fixedly arranged at a rearmost end of the console main body.

11. The vehicle body according to claim 10, wherein the console box is disposed in a front cabin of the vehicle in between a driver seat and a pedestrian seat.

12. The vehicle body according to claim 10, wherein the sliding pin rotates and slides to the second position to align with the fixed pin.

13. The vehicle body according to claim 10, wherein the first position is a close state of the console box the console lid is in proximal to the dashboard of the vehicle and the second position is an open state of the console box the console lid is in proximal to a rear cabin of the vehicle.

14. The vehicle body according to claim 10, wherein the rearmost end corresponds to the second position of the console lid.

15. The vehicle body according to claim 10, wherein the console box in which the console lid is at the second position provides access to a first storage section in the console main body, and the console lid is substantially parallel to the upper surface of the console main body.

16. The vehicle body according to claim 10, wherein the console box in which the console lid is at the second position provides access to a second storage section in the console main body, the second storage section is adjacent to the first storage section, and the console lid is substantially at an angle X from the upper surface of the console main body.

17. The vehicle body according to claim 16, wherein the thread after receiving the fixed pin allows the sliding pin to rotate about the fixed pin causing the console lid to rotate substantially at the angle X.

18. The vehicle body according to claim 10, wherein a pitch of the thread is equal to a diameter of the fixed pin.

19. A method for assembling a console box, comprising:
disposing a sliding rail on a first longitudinal side of a console main body along a longitudinal direction of the console box;
slidably arranging a console lid to the sliding rail such that the console lid is slidable from a first position to a second position along an upper surface of the console main body; and
disposing a first section of a sliding pin on a second longitudinal side of the console lid such that a second section of the sliding pin is slidable in a front-rear direction inside a cavity provided on the sliding rail,
wherein the console lid is configured to slide to the second position, allowing a thread embossed on an outermost surface of the second section to receive a fixed pin fixedly arranged at a rearmost end of the console main body.

20. The method according to claim 19, wherein the first position is a closed state of the console box, the console lid is in proximal to the dashboard of the vehicle and the second position is an open state of the console box, the console lid is in proximal to a rear cabin of the vehicle.
